(19) United States
(12) Patent Application Publication
(10) Pub. No.: US 2003/0234216 A1
(43) Pub. Date: Dec. 25, 2003

(54) Filtrating filter

(75) Inventor: Tadaki Morimura, Mino-shi (JP)

Correspondence Address: BACON & THOMAS, PLLC, 625 SLATERS LANE, FOURTH FLOOR, ALEXANDRIA, VA, 22314

(73) Assignee: Morimura Kosan Kabushiki Kaisha, Osaka-fu (JP)

(21) Appl. No.: 10/265,671

(22) Filed: Oct. 8, 2002

(30) Foreign Application Priority Data
Jun. 25, 2002 (JP) 2002-184093

(51) Int. Cl. B01D 24/00; B01D 29/00

(52) U.S. Cl. 210/483; 210/503; 210/508

(57) ABSTRACT

Large diameter nodes integrally formed on a linear fiber at an appropriate interval to form a fiber body, so that multiple fiber bodies are attached to a support member in a state where slits are formed between adjoining fibers due to the large diameter nodes by arranging multiple fiber bodies in parallel with one another or laminating the multiple fiber bodies with one another. It is preferable that a thickness of the fiber of the fiber body is set to range from 0.003 to 0.05 mm, and an outer diameter of each large diameter node is set to be 1.03 to 1.50 times as large as the thickness of the fiber, and an interval of the large diameter nodes is set to be 5 to 100 times as large as the thickness of the fiber. With such a construction, it is possible to obtain the filtrating filter which is simple in construction and manufactured with ease, particularly capable of easily forming slits to have an arbitrary size through which liquid or gas to be suitably filtrated.

### FIELD OF THE INVENTION

The invention relates to a filtrating filter for purifying liquid or gas.

### BACKGROUND OF THE INVENTION

It has been known that conventional filtrating filters have various constructions and employ variety of materials. However, the conventional filtrating filters are generally complex in construction and manufactured with difficulty, rendering the filtrating filters very expensive. Particularly, it is necessary that the filtrating filter has pores for preventing a solid matter from passing therethrough and rendering only liquid, gas and the like to pass therethrough. Although the size of each pore is differentiated depending on kinds of liquid or gas which is a filtrating objective for an intended use thereof, it has been difficult to form each pore of the conventional filtrating filters to have an arbitrary size.

### SUMMARY OF THE INVENTION

Accordingly, it is an object of the invention to provide a filtrating filter which is simple in construction, manufactured with ease, particularly capable of easily forming pores by means of slits through which liquid or gas passes so as to have an arbitrary size depending on intended use.

### BRIEF DESCRIPTION OF THE DRAWINGS

FIG. 1 is a front view of a fiber body constituting one filtrating filter;

FIG. 2 is front view showing a state where the multiple fiber bodies are arranged in parallel with one another;

FIG. 3 is perspective view showing a state where one continuous fiber body is wound around a support member to form a cylindrical filter;

FIG. 4 is a sectional view taken along line A-A in FIG. 3;

FIG. 5 is a perspective view showing a state where multiple fiber bodies are arranged in parallel with one another to form a screen shaped filter; and

FIG. 6 is a sectional view showing a state where multiple screen shaped filters are laminated with one another and attached to a case of a filter unit.

### BEST MODE FOR CARRYING OUT THE INVENTION

According to a filtrating filter of the invention, large diameter nodes 3 integrally provided on a linear fiber 2 at an appropriate interval to form a fiber body 1, wherein multiple fiber bodies 1 are arranged in parallel or laminated with one another and the resultant multiple fiber bodies 1 are attached to a support member 5 in a state where slits 4 are formed between adjoining fibers 2 by the large diameter nodes 3.

According to the filtrating filter of the invention, it is effective that a thickness of the fiber 2 of the fiber body 1 is set to range from 0.003 to 0.35 mm, and an outer diameter of each large diameter node 3 is set to be 1.03 to 1.50 times as large as the thickness of the fiber 2, and an interval of the large diameter nodes 3 is set to be 5 to 100 times as large as the thickness of the fiber 2.

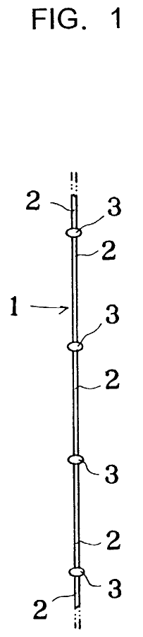

A preferred embodiment of the invention is now described with reference to accompanying drawings. FIG. 1 shows one fiber body 1. The fiber body 1 includes the linear fiber 2 and the large diameter nodes 3 formed integrally with the fiber 2 at an appropriate interval, the shape of the large diameter nodes 3 is arbitrary, e.g., wenny or ball shaped.

A material of the fiber body 1 may be a synthetic resin such as polypropylene or the like, metal or other inorganic material, which can be appropriately selected depending on use conditions or intended use.

The thickness of the fiber 2 of the fiber body 1, i.e., a diameter of the fiber is set to be 0.5 mm at the maximum. If the thickness is larger than 0.5 mm, the slits 4 formed between the fibers 2 by the large diameter nodes 3 become too wide so that the slits 4 can not catch minute solid matters, thereby lowering filtrating performance. It is more preferable that the line diameter ranges from 0.003 to 0.35 mm. The fiber body 1 having such a very small thickness can catch a small solid matter while the slits 4 formed when providing the large diameter nodes 3 are neither too wider nor too narrower, so that the filtrating filter can keep a sufficient filtrating performance and there does not hardly occur clogging and the filtrating efficiency is not prone to be lowered.

A person skilled in the art can determine methods of forming the large diameter nodes 3 of the fiber body 1. For example, if a material of the fiber 2 is a easily transformable metal, it is possible to employ a method wherein a part of the fiber 2 can be transformed by applying a pressure such as a blow, a shock or the like to form the large diameter nodes 3. If a material of the fiber 2 is fusable metal, a synthetic material or the like, it is possible to employ a method wherein a part of the fiber 2 is fused by applying an electric discharge treatment thereto or applying heat ray, a laser beams or the like thereto in spot to form the large diameter nodes 3. Further, if a material of the fiber 2 is a synthetic resin, it is possible to employ a method wherein particles are mixed with a synthetic resin and it is subjected to extrusion process so that the particles form the large diameter nodes 3. Further, it is also possible to employ a method wherein particles are sprayed onto the fiber 2 to attach thereto so that the particles form the large diameter nodes 3.

A size (outer diameter) of each large diameter node 3 is preferable to be 1.03 to 1.50 times as large as a thickness (line diameter) of the fiber 2. If the outer diameter of each large diameter node 3 is larger than these values, the slit 4 formed between the fibers 2 becomes too large to catch minute solid matters, and a filtrating performance is prone to be lowered, while on the other hand, if the outer diameter of each large diameter node 3 is smaller than these values, the slit 4 formed between the fibers 2 becomes too small, and hence clogging is prone to occur and a filtrating performance is prone to be lowered.

The interval between the large diameter nodes 3 is preferable to be 5 to 100 times as large as a thickness (line diameter) of the fiber 2. If the interval between the large diameter nodes 3 becomes larger than these values, adjoining fibers 2 easily contact each other at the middle portion between the large diameter nodes 3, and hence there is a likelihood that the slit 4 is hardly maintained. On the other hand, if the interval between the large diameter nodes 3 is smaller than these values, the number of the large diameter node 3 is too increased, so that the large diameter nodes 3 between the adjoining fiber bodies 1 interfere with each other, namely, the large diameter nodes 3 contact each other, there is a likelihood that the slit 4 become too wide.

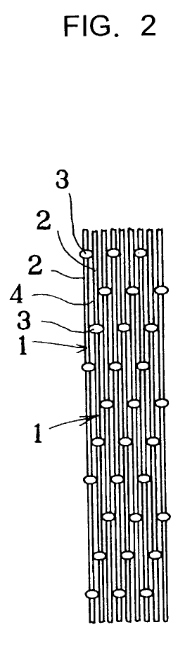

The multiple fiber bodies 1 can be attached to the support member 5 in a state of film shape as shown in FIG. 2 by arranging them in parallel or in plate shape laminated with each other. The shape and the construction of the support member 5 can be arbitrarily determined. A person skilled in the art can determine a method of attaching the fiber bodies 1 to the support member 5 in a state where they are arranged in parallel with one another,.

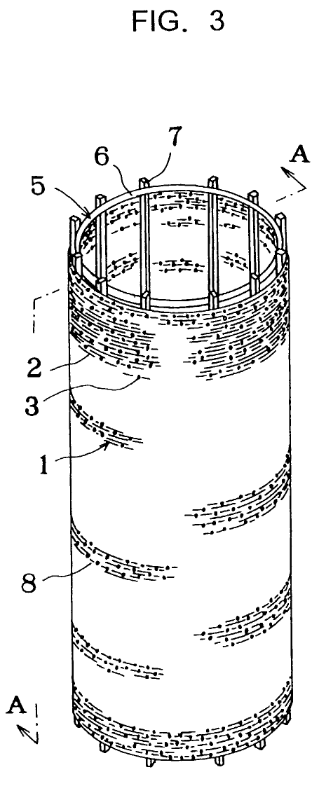

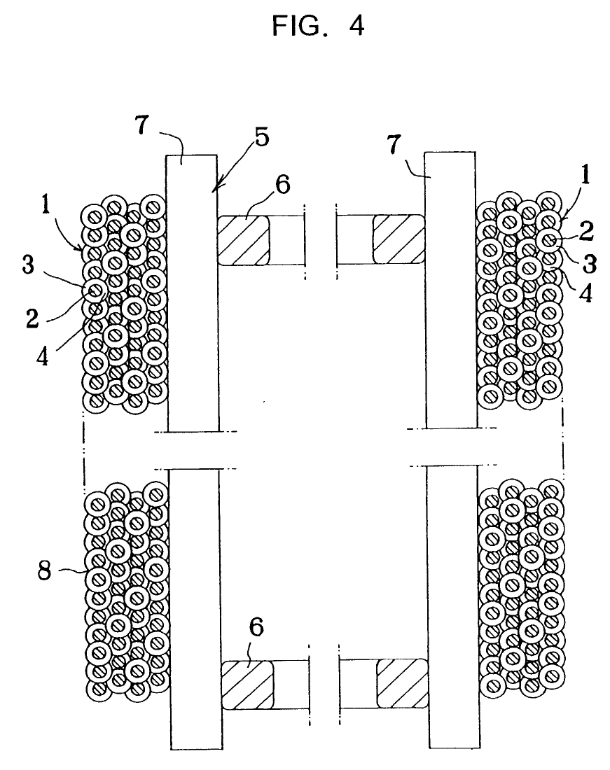

For example, as shown in FIGS. 3 and 4, multiple ring shaped lateral bars 6 and vertical bars 7 are combined with each other to form a cage shaped (cylindrical or other shaped) support member 5 and a continuous fiber body 1 is wound around the support member 5 to be rendered in a laminated state, thereby forming the cylindrical filter 8. With such a construction, comparing with the case where same filtrating filter is formed by preparing a large number of fiber bodies 1 each having the same length and arranging the large number of fiber bodies 1 in parallel or laminated with one another and then fixing both ends of the fiber bodies 1 by frames, the filtrating filter of this construction can dispense with the cutting of the fiber bodies land the fixing both ends of the fiber bodies 1 to frames, so that the filtrating filter of this construction can be easily manufactured and a three dimensional filtrating filter can be easily manufactured.

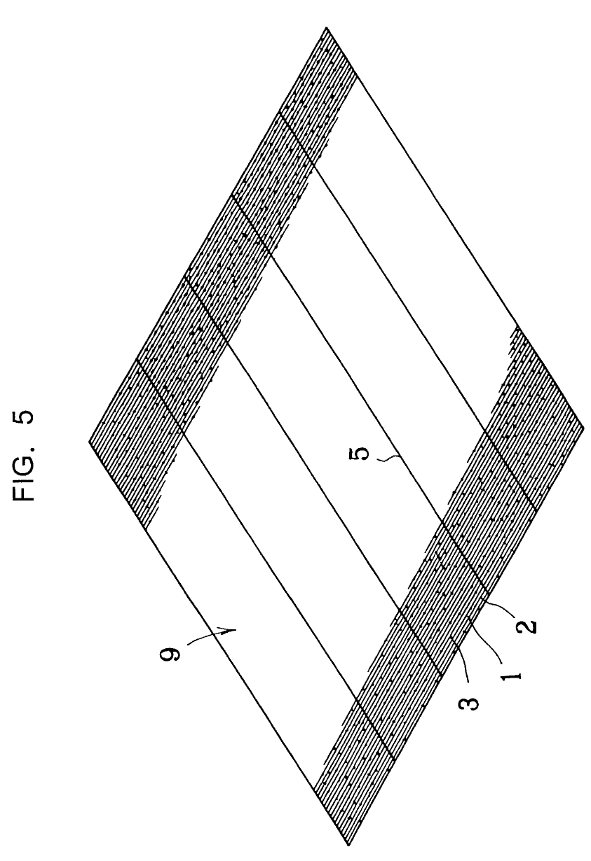

Further, as shown in FIG. 5, when a large number of fiber bodies 1 are arranged vertically in parallel with one another, and laterally directed support members 5 are arranged at given interval of the fiber bodies 1 which are arranged in vertical direction, then intersecting points between the support members 5 and fiber bodies 1 are jointed with each other by welding or adhesion or the like, thereby forming a screen shaped filter 9. Although same material as the fiber body 1 can be used for the support member 5, it is a matter of course that other materials can be used for the support member 5.

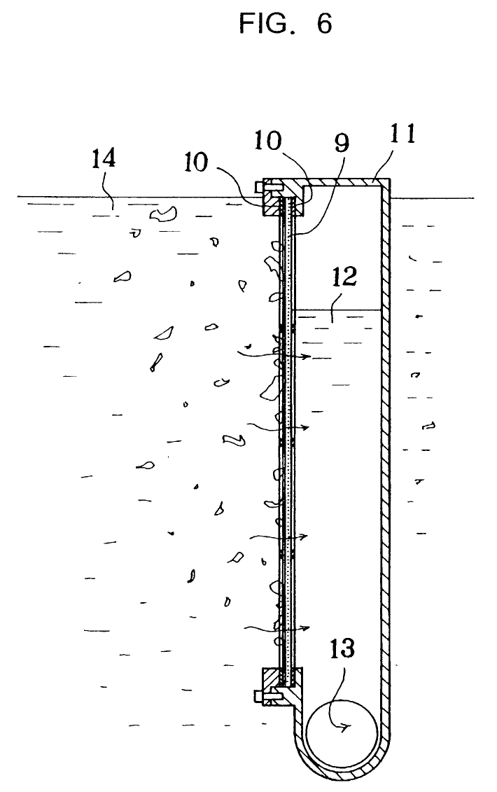

For example, as shown in FIG. 6, the filtrating filter can be used such that multiple screen shaped filters 9 are laminated with one another and both side surfaces are clamped and supported by lattice shaped holders 10, thereby forming an integrated filter body, then the integrated body is attached to a case 11 of a filter unit which is installed inside a purifying tank for filtrating waste water 14 so as to cover an opening of the case 11. Filtrate 12 which entered an inner space of the case 11 after passing through the filter 9 can be discharged outside the purifying tank through a pipe 13 connected to the case 11. Further, a sensor (not shown) for detecting a water level of the filtrate 12 which is stored in the inner space of the case 11 can be installed, wherein a valve (not shown) attached to the pipe 13 is changed over when the water level of the filtrate 12 lowers to a given position so as to reflow the filtrate 12 whereby the filter 9 is subjected to an adverse purification, thereby solving the problem of clogging of the filter 9.

As mentioned above, fiber bodies 1 are arranged in parallel or laminated with one another, fibers 2 are rendered in a state to be arranged in parallel with one another, however, there exist the large diameter nodes 3 which serve as spacers, and hence the adjoining fibers 2 of the fiber bodies 1 are not brought into contact with each other, but spaced apart from each other by the size of the diameter of each large diameter node 3, thereby producing the slits 4 between the respective fiber bodies 1.

Accordingly, the size of the slit 4 can be arbitrarily adjusted by changing the size (outer diameter) of each large diameter node 3.

Since the filtrating filter of the invention is merely attached to the support member 5 by arranging the fiber bodies 1 in parallel with one another or laminating the fiber bodies 1 one another, the construction thereof becomes simple and it can be easily manufactured.

Further, the fiber body 1 has a construction wherein the large diameter nodes 3 are integrally formed with the linear fiber 2 at an appropriate interval, when the fiber bodies 1 are arranged in parallel or laminated with one another, the respective fiber bodies 1 are spaced apart from each other by the large diameter nodes 3, and the slits 4 are formed between the fiber bodies 1, so that there hardly occurs clogging in the fiber bodies 1.

Still further, although it is necessary that the size of the slit 4 is differentiated depending on the kind of liquid or gas which is a filtrating objective or intended use thereof, it is possible to form the slit 4 having an optimum size suited for the filtrating objective or intended use by changing the size of each large diameter node 3. Further, when the thickness of the fiber body 1 is set to range from 0.003 to 0.35 mm and the outer diameter of each large diameter node 3 is set to be 1.03 to 1.50 times as large as the thickness of the fiber 2, the slit 4 formed between the adjoining fibers 2 is rendered neither too wider nor too narrower so that the slit 4 can catch minute solid matters so as to keep a sufficient filtrating performance, and also clogging hardly occurs, thereby avoiding the lowering of the filtrating efficiency. Further, Since the interval between the large diameter nodes 3 is set to be 5 to 100 times as large as the thickness of the fiber 2, the adjoining fibers 2 do not contact each other at the middle portion of the two large diameter nodes 3so that the slit 4 is easily maintained constant, and also because the number of large diameter nodes 3 is limited so that the large diameter nodes 3 the respective fiber bodies 1 don't overlap each other, namely, both the large diameter nodes 3 don't contact each other, thereby preventing the slit 4 is from rendering so wide.

What is claimed is:

1. A filtrating filter comprising:
large diameter nodes integrally formed on a linear fiber at an appropriate interval to form a fiber body, so that multiple fiber bodies are attached to a support member in a state where slits are formed between adjoining fibers due to the large diameter nodes by arranging multiple fiber bodies in parallel with one another or laminating the multiple fiber bodies with one another.

2. The filtrating filter according to claim 1, wherein a thickness of the fiber of the fiber body is set to range from 0.003 to 0.35 mm, and an outer diameter of each large diameter node is set to be 1.03 to 1.50 times as large as the thickness of the fiber, and an interval of the large diameter nodes is set to be 5 to 100 times as large as the thickness of the fiber.
